(19) United States
(12) Patent Application Publication
(10) Pub. No.: US 2007/0078205 A1
(43) Pub. Date: Apr. 5, 2007

(54) Hot melt adhesive composition having improved stability

(76) Inventor: David John St.Clair, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(21) Appl. No.: 11/243,170

(22) Filed: Oct. 4, 2005

(51) Int. Cl. C08K 5/00

(52) U.S. Cl. 524/287

(57) ABSTRACT

An adhesive composition which includes a block copolymer of a mono alkenyl arene and a conjugated diene, and a plasticizer is provided. The block copolymer is at least one unsaturated block copolymer having a mono alkenyl arene content of equal to or greater than 60 weight percent and a modulus of less than 125,000 psi. The plasticizer is an aromatic ester or a liquid aromatic resin. The adhesive formed from the adhesive composition is characterized by having improved hot aging stability over adhesives based on prior block copolymers containing a conjugated diene elastomeric block.

### FIELD OF THE INVENTION

The present invention is directed to an improved hot melt adhesive composition, useful in preparing pressure sensitive and non-pressure sensitive adhesives, which has high resistance to gelation at elevated temperatures. More specifically, the present invention is directed to a hot melt adhesive composition which includes at least one unsaturated block copolymer having a high monoalkenyl arene content, a modulus of less than 125,000 psi and an aromatic plasticizer.

### BACKGROUND OF THE INVENTION

The use of adhesives is ubiquitous in the manufacture of all types of products. A very large number of these adhesives, especially pressure sensitive adhesives (PSA), are based on block copolymers of mono alkenyl arenes and conjugated dienes.

A major disadvantage to broad use of the aforementioned class of adhesives was the environmentally undesirable effect of solvents employed in applying adhesive compositions from solution. Therefore, hot melt adhesives, which do not include a solvent, were developed to eliminate this environmental hazard.

The degradation characteristics of a hot melt adhesive based on a mono alkenyl arene-conjugated diene block copolymer depend on the type of diene in the block copolymer. If the diene is butadiene, the resulting hot melt adhesive composition will have high tendency to gel at the elevated temperatures to which these adhesives must be heated in order to be applied as hot melt adhesives. This tendency is due to the well known behavior of polybutadiene rubber to degrade by both scission, to form lower molecular weight (MW) fragments, as well as crosslinking, to form higher MW fragments which ultimately lead to gel formation. This tendency toward gelation can be eliminated by processing the hot melt adhesive under an inert gas blanket but this adds to the expense of the process. Gelation can also be eliminated if the diene in the block copolymer is isoprene since polyisoprene rubber is known to degrade only by scission to form lower MW fragments. Since isoprene is a more expensive monomer than butadiene, block copolymers containing isoprene are more expensive than those containing butadiene. Gelation can also be eliminated by hydrogenating the butadiene based block copolymer but this also makes the polymer more expensive.

It is thus apparent that there is a strong need in the art for a new adhesive composition which provides improved hot aging properties to be better suited to application as a hot melt adhesive, without sacrificing adhesive properties associated with the elastomeric nature of mono alkenyl arene-conjugated diene block copolymers.

### SUMMARY OF THE INVENTION

A hot melt adhesive composition has now been developed which has low tendency toward gelation at elevated temperatures associated with butadiene-based block copolymer-containing adhesive compositions of the prior art. The newly developed adhesive composition, moreover, provides adhesive properties equivalent to those of prior art block copolymer-containing adhesive compositions albeit without the tendency to crosslink at the elevated temperatures associated with hot melt adhesive application.

In accordance with the present invention, an adhesive composition is provided which includes at least one unsaturated block copolymer that has a high monoalkenyl arene content and a modulus of less than 125,000 psi; and a plasticizer selected from the group consisting of aromatic esters and liquid aromatic resins. The at least one unsaturated block copolymer having the high monoalkenyl arene content and modulus of less than 125,000 psi will be described in greater detail herein below. Throughout this application, the aforementioned block copolymer can also be referred to as ‘an unsaturated high monoalkenyl arene content block copolymer having a modulus of less than 125,000 psi’.

It has been discovered that the tendency toward gelation of the hot melt adhesive can be eliminated by making the rubber or elastomeric block in the block copolymer a mono alkenyl arene/conjugated diene copolymer. Since these monomers are readily available, they are reasonably priced so this inventive block copolymer can replace a conventional block copolymer with almost no increase in cost.

The block copolymers that can be used in the present invention are unsaturated block copolymers having a monoalkenyl arene (polystyrene) content equal to or greater than about 60 weight percent based on the total weight of the block copolymer and a modulus less than about 125,000 psi. These block copolymers include at least two A blocks and at least one B block, wherein each A block is a mono alkenyl arene homopolymer block and each B block is selected from (a) a polymer block of at least one conjugated diene and at least one mono alkenyl arene and having a random distribution, (b) a polymer block of at least one conjugated diene and at least one mono alkenyl arene and having a blocked distribution; (c) a polymer block of at least one conjugated diene and at least one mono alkenyl arene and having a tapered distribution; and (d) a polymer block of at least one conjugated diene and at least one mono alkenyl arene and having a controlled distribution.

### DETAILED DESCRIPTION OF THE INVENTION

The adhesive composition of the present invention comprises a block copolymer of a mono alkenyl arene and a conjugated diene and a plasticizer selected from the group consisting of an aromatic ester and a liquid aromatic resin.

Specifically, the block copolymers utilized in the present invention broadly comprise any unsaturated block copolymers that meet the following criteria:

(1) the block copolymer has a mono alkenyl arene content equal to or greater than 60 weight percent, based on the total weight of the block copolymer;

(2) the block copolymer has a modulus less than about 125,000 psi; and

(3) the block copolymer has at least two A blocks and at least one B block wherein each A block is a mono alkenyl arene polymer block and wherein each B block is selected from:
(a) polymer blocks having at least one conjugated diene and at least one mono alkenyl arene and having a random distribution;
(b) polymer blocks having at least one conjugated diene and at least one mono alkenyl arene and having a blocked distribution;
(c) polymer blocks having at least one conjugated diene and at least one mono alkenyl arene and having a tapered distribution; and
(d) polymer blocks having at least one conjugated diene and at least one mono alkenyl arene and having a controlled distribution.

One important aspect of the block copolymers used in preparing the adhesive composition of the present invention is the mono alkenyl arene content. As noted hereinbefore, the mono alkenyl arene content should be equal to or greater than 60 weight percent, based on the total weight of the block copolymer. Preferably, the mono alkenyl arene content will range from about 60 to about 85 weight percent for the block copolymer. In alternative embodiments, the mono alkenyl arene content will range from about 70 to about 80 weight percent, more preferably from about 73 to about 78 weight percent.

Another important aspect of the block copolymers utilized in the present invention is the modulus of the block copolymer. As used herein, the term “modulus” refers to flexural modulus according to ASTM D-790 (Procedure B). This modulus refers to the ratio of stress to strain for a given polymer. The block copolymers used in the present invention will have a modulus of less than about 125,000 psi. The modulus is preferably less than about 115,000 psi and even more preferably less than about 110,000.

The mono alkenyl arenes utilized in the A and B blocks of the block copolymers are independently selected from styrene, alpha-methylstyrene, para-methylstyrene, vinyl toluene, vinylnaphthalene, and para-butyl styrene or mixtures thereof. Of these, styrene is the most preferred.

The conjugated dienes of the block B blocks are independently selected from 1,3-butadiene and substituted butadienes, such as, for example, isoprene, piperylene, 2,3-dimethyl-1,3-butadiene, and 1-phenyl-1,3-butadiene, or mixtures thereof. Of these, isoprene and 1,3-butadiene are the most preferred with 1,3-butadiene being the more preferred of the two.

While a wide range of molecular weights of the block copolymers utilized in the compositions of the present invention can be used, in many instances the number average molecular weight of each A block will independently range from about 5,000 to about 200,000, preferably from about 7,500 to about 150,000, and the number average molecular weight of each B block will independently range from about 10,000 to about 100,000, preferably from about 10,000 to about 75,000, for the sequential block copolymers and from about 5,000 to about 50,000, preferable from about 5,000 to about 37,500, for the coupled block copolymers.

As noted above, the B block(s) of the block copolymers that can be utilized in the present invention are selected from a variety of midblocks. More specifically, within the scope of the contemplated block copolymers are those block copolymers wherein the midblocks are considered to have a distribution configuration that is “random”, “blocked”, “tapered” or “controlled”.

More specifically, in embodiment (a), B comprises a polymer block of at least one conjugated diene and at least one mono alkenyl arene wherein the B block has a random distribution. As used herein, the phrase “random distribution” means that the distribution of monomers from one end of the block to the other end is roughly uniform (e.g., it is a statistical distribution based on the relative concentrations of the monomers). Preferably, in this embodiment, the conjugated diene of each B block is independently selected from isoprene and butadiene, with butadiene being the most preferred, and the mono alkenyl arene is as defined hereinbefore with regard to A, with styrene being the most preferred.

In the second embodiment (b), B comprises a polymer block comprising at least one conjugated diene and at least one mono alkenyl arene, wherein the B block has a blocked distribution. As used herein, the phrase “blocked distribution” means that the distribution is a nonuniform distribution in which the A monomers (or in the alternative the B monomers) are more likely to be grouped with other A monomers (or in the case of the B monomers, with other B monomers) than is found in a statistical (i.e., “random”) distribution thereby resulting in a short “defined” monomer block. Preferably, in this embodiment, the conjugated diene of each B block is also independently selected from isoprene and butadiene with butadiene being the most preferred and the mono alkenyl arene is as defined hereinbefore with regard to A, with styrene being the most preferred.

In the third embodiment (c), B comprises a polymer block comprising at least one conjugated diene and at least one mono alkenyl arene, wherein the B block has a tapered distribution. As used herein, the phrase “tapered distribution” means that the distribution is a nonuniform distribution in which the concentration of A monomer (or in the alternative, B monomer) at one end of the block is greater than at the other end of the block (it gradually declines from one end of the block to the other end of the block). As in the other embodiments, preferably the conjugated diene of each B block is also independently selected from isoprene and butadiene with butadiene being the most preferred and the mono alkenyl arene is as defined hereinbefore with regard to A, with styrene being the most preferred.

In the fourth and final embodiment (d), B comprises a polymer block comprising at least one conjugated diene and at least one mono alkenyl arene, wherein the B block has a controlled distribution. For purposes herein, the phrase “controlled distribution” is as defined in co-pending and commonly assigned U.S. patent application Ser. No. 10/359,981, filed Feb. 6, 2003 and entitled “NOVEL BLOCK COPOLYMERS AND METHOD FOR MAKING SAME”. The entire contents of the Ser. No. 10/359,981 patent application, are thus incorporated herein by reference. More specifically, the molecular structure of the controlled distribution block copolymer has the following attributes: (1) terminal regions adjacent to the mono alkenyl arene homopolymer (“A”) blocks that are rich in (i.e., having a greater than average amount of) conjugated diene units; (2) one or more regions not adjacent to the A blocks that are rich in (i.e., having a greater than average amount of) mono alkenyl arene units; and (3) an overall structure having relatively low mono alkenyl arene, e.g., styrene, blockiness. For the purposes hereof, “rich in” is defined as greater than the average amount, preferably 5% greater than the average amount. As in the other embodiments, preferably the conjugated diene of each B block is also independently selected from isoprene and butadiene with butadiene being the most preferred and the mono alkenyl arene is as defined hereinbefore with regard to A, with styrene being the most preferred.

The block copolymers of the present invention may be prepared by any of the methods known in the art, including sequential polymerization and coupling using standard coupling agents. Examples of block copolymers that may be used in the adhesives of the present invention, as well as the methods of preparing such block copolymers, include but are not limited to: polymers and methods disclosed in U.S. Pat. No. 4,925,899, U.S. Pat. No. 6,521,712, U.S. Pat. No. 6,420,486, U.S. Pat. No. 3,369,160, U.S. Pat. No. 6,265,485, U.S. Pat. No. 6,197,889, U.S. Pat. No. 6,096,828, U.S. Pat. No. 5,705,569, U.S. Pat. No. 6,031,053, U.S. Pat. No. 5,910,546, U.S. Pat. No. 5,545,690, U.S. Pat. No. 5,436,298, U.S. Pat. No. 4,248,981, U.S. Pat. No. 4,167,545, U.S. Pat. No. 4,122,134, U.S. Pat. No. 6,593,430, and U.S. patent application Ser. No. 10/359,981, each incorporated herein by reference.

As noted hereinbefore, the block copolymers used in the present invention have at least two A blocks and at least one B block. Accordingly, the block copolymers used in the present invention may comprise any block copolymer which meets the criteria for the present invention, including block copolymers that are linear sequential, as well as block copolymers that are coupled (including linear coupled and branched (multi-arm) coupled block copolymers). When the block copolymer is linear coupled or multi-arm coupled, the arms may be symmetrical or asymmetrical.

While not wishing to be bound by the structure of the present block copolymers, representative structures which contain at least two A blocks and at least one B block and which
(1) (A-A₁-B-C)ₘ-X-(C-B-A₁)ₙ, wherein each A and A₁ is independently a polymer block of mono alkenyl arene, each B is independently a copolymer block of mono alkenyl arene and conjugated diene, each C is independently a block of conjugated diene and m≦n and m+n is 3 to 20.
(2) A₁-B₁-B₂-A₂, wherein each A₁ and A₂ is independently a polymer block of mono alkenyl arene and each B₁ and B₂ is independently a polymer block of mono alkenyl arene and conjugated diene.
(3) A-B-A, (A-B)ₙ, (A-B)ₙ-A, (A-B-A)ₙ-X, or (A-B)ₙ-X, wherein each A is independently a polymer block of mono alkenyl arene, each B is independently a polymer block of mono alkenyl arene and conjugated diene, X is the residue of a coupling agent and n is from 2 to 30.
(4) A-A₁-B-B₁-X-B₁-B-A₁-A, A-B-B₁-X-B-A, A-A₁-B-B₁-X-B₁-B-A, wherein each A and A₁ is independently a polymer block of mono alkenyl arene and each B and B₁ is independently a polymer block of mono alkenyl arene and conjugated diene
(5) B-(A-B)ₙ; X-[(A-B)ₙ]ₘ₊₁; X-[(B-A)ₙ]ₘ₊₁; X-[(A-B)ₙ-A]ₘ₊₁; X-[(B-A)ₙ-B)]ₘ₊₁; Y-[(A-B)ₙ]ₘ₊₁; Y-[(B-A)ₙ]ₘ₊₁; Y-[(A-B)ₙ-A]ₘ₊₁; Y-[(B-A)ₙ-B]ₘ₊₁ wherein each A is independently a polymer block of mono alkenyl arene, each B is independently a polymer block of mono alkenyl arene and conjugated diene, X is a radical of an n-functional initiator, Y is a radical of an m-functional coupling agent and m and n are whole numbers from 1 to 10.
(6) (A₁-A₂-B₁-B₂-B₃)ₙ-X-(B₃-B₂-B₁-A₂)ₘ wherein each A₁ and A₂ is independently a polymer block of mono alkenyl arene, each B₁, B₂ and B₃ is independently a polymer block of mono alkenyl arene and conjugated diene and n and m are each independently 0 or ≧3.
   independently a polymer block of mono alkenyl arene and conjugated diene and n and m are each independently 0 or ≧3.
(7) A-A₁-B-X-B-A₁-A, A-B-X-B-A, A-A₁-B-X-B-A wherein each A is independently a polymer block of mono alkenyl arene and each B is independently a polymer block of mono alkenyl arene and conjugated diene.
(8) A₁-B₁-C₁, A₁-C₁-B₁, A₁-B₁-C₁-A₂, A₁-B₁-C₁-B₂-A₂, A₁-C₁-B₁-C₂-A₂, A₁-B₁-B₂-C₁-A₂, A₁-B₁-C₁-B₂-C₂-B₃-A₂, A₁-B₁-A₂-B₂-C₁-A₃, A₁-B₁-C₁-A₂-C₂-B₂-A₃, A₁-B₁-A₂-C₁-B₂, A₁-B₁-A₂-B₂-C₁, wherein each A₁, A₂ and A₃ is independently a mono alkenyl arene, each B₁ and B₂ is independently a polymer block of mono alkenyl arene and conjugated diene and each C₁ and C₂ is independently a polymer block of conjugated diene.

With regard to the above-noted structures specifically made by coupling, those skilled in the art will recognize that these polymers may also include a small amount of diblock (i.e., up to about 10% diblock).

As used herein, in those instances where it is noted that the blocks are “independently” a polymer block, such polymer blocks can be the same, or they can be different.

Also contemplated within this scope are various types of block copolymers that are grafted or functionalized with various functional groups such as unsaturated monomer having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of functionalizing such block copolymers can be found in U.S. Pat. No. 4,578,429 and U.S. Pat. No. 5,506,299. In another manner, the copolymers employed in the present invention may be functionalized by grafting silicon or boron-containing compounds to the polymer as taught, for example, in U.S. Pat. No. 4,882,384. In still another copolymers of the present invention may be functionalized by reacting at least one ethylene oxide molecule to the polymer as taught in U.S. Pat. No. 4,898,914, or by reacting the polymer with carbon dioxide as taught in U.S. Pat. No. 4,970,265. Still further, the block copolymers of the present invention may be metallated as taught in U.S. Pat. No. 5,206,300 and U.S. Pat. No. 5,276,101, wherein the polymer is contacted with an alkali metal alkyl, such as a lithium alkyl. And still further, the block copolymers of the present invention may be functionalized by grafting sulfonic groups to the polymer as taught in U.S. Pat. No. 5,516,831.

It should be noted that the above-described unsaturated block copolymers used in the present invention may, if desired, be readily prepared by the methods set forth above. However, since many of these copolymers are commercially available, it is usually preferred to employ the commercially available polymer as this serves to reduce the number of processing steps involved in the overall process. Examples of the above block copolymers which are commercially available include, but are not limited to, Styrolux®3G55 (commercially available from BASF Aktiengesellschaft), XK40 (commercially available from Chevron-Phillips Corporation) and KRATON® MD 6459 (commercially available from KRATON Polymers LLC).

The above-discussed block copolymers are advantageously employed as a component of the adhesive composition of the present application. Although the invention is independent of any theory explaining its operation, it is believed that the double bonds in the mid-block or mid-blocks are sterically hindered by the adjacent mono alkenyl arene units, e.g., styrene. This steric hindrance of the double bonds reduces the tendency towards crosslinking, thus limiting the tendency toward gelation of the hot melt adhesive composition in the hot molten state.

The block copolymer of the adhesive composition is present in an amount from about 25% to about 50% by weight based on the total weight of said adhesive composition, preferably from about 30% to about 40% by weight.

The second component of the adhesive composition is a plasticizer. The plasticizer is an aromatic compound selected from the group consisting of an aromatic ester and a liquid aromatic resin.

In the embodiment wherein the plasticizer is an aromatic ester, the aromatic ester is preferably a benzoate or a phthalate compound. Preferred examples of such esters are butyl benzyl phthalate, 2,2,4-trimethyl pentanediol dibenzoate, 1,4-cyclohexane dimethanol dibenzoate and isodecyl benzoate.

A second class of plasticizers of the adhesive composition is liquid aromatic resins. A liquid aromatic resin is a polymer made of aromatic monomers whose softening point is less than room temperature. A particularly preferred class of the liquid aromatic resins is aromatic resins whose softening points are about 5° C. or lower.

In a preferred embodiment, the adhesive composition includes as a third component, a tackifying agent. The tackifying agent is a solid aromatic resin or an aromatic modified aliphatic resin. Thus, the tackifying agent resin is a solid polymer made of aromatic monomers or a mixture of aromatic and aliphatic monomers whose softening point is greater than ambient temperature. Both the aromatic resins and the mixed aromatic/aliphatic resins are referred to herein as an aromatic tackifying resin. They are characterized in that, just as the aforementioned liquid aromatic resin is a liquid under ambient conditions, the solid aromatic tackifying agent resin is a solid under ambient conditions. Preferably, the softening point of the solid aromatic tackifying agent resin is in the range of from about 80° C. to about 110° C., more preferably from about 85° C. to about 100° C. Solid aromatic tackifying agent resins provide improved peel strength and provide greater resistance to shear adhesion failure, as measured at higher temperatures in the shear adhesion failure temperature test.

As suggested above, adhesive compositions of the present invention may be provided wherein no tackifying agent is present. In those embodiments, it is preferred that the plasticizer be a liquid aromatic resin. Although the invention is not predicated upon any theory explaining its effectiveness, it is believed that a liquid aromatic resin imparts tackiness to an adhesive composition insofar as it is chemically closely related to solid aromatic resins, which are tackifying agents of the adhesive composition. The liquid aromatic resin also acts as a plasticizer insofar as it softens block copolymers of the type employed in the adhesive composition.

In preferred embodiments of the adhesive composition, which do not include a tackifying agent, the composition comprises from about 25% to about 50% by weight, more preferably from about 30% to about 40% by weight, of the block copolymer and from about 50% to about 75% by weight of the plasticizer. Such compositions are preferably employed in pressure sensitive adhesive (PSA) compositions. As indicated above, the plasticizer component of these compositions is preferably a liquid aromatic resin.

Preferred embodiments of the adhesive composition, which additionally include a tackifying agent, are employed in both PSA and non-PSA compositions. In these three-component adhesive compositions, the block copolymer is again present in a concentration of from about 25% to about 50% by weight, preferably from about 30% to about 40%. The plasticizer is present in a concentration of from about 10% to about 30% by weight. The tackifying agent is present in a concentration of from about 15% to about 60% by weight.

In preferred embodiments wherein three-component adhesive compositions are PSA compositions, the plasticizer is preferably present in a concentration of from about 20% to about 30% by weight and the tackifying agent is present in a concentration of from about 15% to about 40% by weight. In preferred embodiments wherein the adhesive composition is a non-PSA composition, the plasticizer is preferably present in a concentration of from about 10% to about 20% by weight. The tackifying agent is present in a concentration of between about 50% and about 60% by weight. In both PSA and non-PSA compositions, the concentration of block copolymer remains unchanged at about 25% to about 50%.

In addition to the above essential components, the adhesive composition may be modified further with the addition of other polymers, fillers, antioxidants, stabilizers, pigments, and other rubber compounding ingredients without departing from the scope of this invention. When one or more of such other components are present in the adhesive compositions of the present invention, they will typically be present in a total amount from about 0.05 weight percent to about 1.5 weight percent based on the total weight percent of the combined components in the adhesive composition.

The adhesive compositions are formulated using techniques well known in the art including, for example, blending of the various components together in a suitable mixer and forming a hot melt thereof.

It is emphasized that all the aforementioned concentrations represent percentages by weight, based on the total weight of the adhesive composition.

### EXAMPLES

The following materials were used in the examples below.

Copolymer 1: An unsaturated block copolymer having a modulus of about 73,000 psi and a polystyrene content of about 75% by weight, commercially available from KRATON Polymers LLC as KRATON® MD6459.

KRATON® D1155: Polystyrene-polybutadiene-polystyrene (S-B-S) block copolymer containing 40% S by weight supplied by KRATON Polymers LLC.

KRATON® D1102: S-B-S block copolymer containing 28% S by weight supplied by KRATON Polymers LLC.

KRATON® D1162: Polystyrene-polyisoprene-polystyrene (S-I-S) block copolymer containing 44% S by weight supplied by KRATON Polymers LLC.

KRATON® D1164: S-I-S block copolymer containing 30% S by weight supplied by KRATON Polymers LLC.

KRATON® MD6932: Polystyrene—Hydrogenated polybutadiene—Polystyrene (S-EB-S) block copolymer containing 20% S by weight supplied by KRATON Polymers LLC.

KRATON® G1652: S-EB-S block copolymer containing 30% S by weight supplied by KRATON Polymers LLC.

Regalite® R1100: Hydrogenated aromatic tackifying resin supplied by Eastman, SP was 100° C.

Wingtackg® 86: Aromatic modified aliphatic tackifying resin supplied by Goodyear, softening point (SP) was 86° C.

Picco® 6100: Aromatic tackifying resin supplied by Eastman, SP was 104° C.

Kristalex® 3100: Aromatic tackifying resin supplied by Eastman, SP was 100° C.

Piccolastic® A5: Liquid aromatic resin plasticizer supplied by Eastman, SP was 5° C.

Benzoflex® 131: Isodecyl benzoate aromatic ester plasticizer supplied by Velsicol.

Benzoflex 352: 1,4-cyclohexane dimethanol dibenzoate aromatic ester plasticizer supplied by Velsicol.

Santicizer® 160: Butyl benzyl phthalate aromatic ester plasticizer supplied by Ferro.

Finester® EH-25: C₁₂₋₁₅ alkyl octanoate aliphatic ester plasticizer supplied by Finetex.

Shellflex® 371: Paraffinic/naphthenic process oil supplied by Shell.

Drakeol® 34: Paraffinic/naphthenic mineral oil supplied by Penreco.

Irganox® 1010: Phenolic antioxidant supplied by Ciba.

The following test methods were used in the examples below.
Ring & Ball Softening Point according to ASTM D-36. Results are in ° C.
Melt Viscosity measured at 177° C. by ASTM D-3236. Results are in Pa.s.
Rolling Ball Tack by ASTM D-3121. Results are in cm.
Loop Tack by ASTM D-6195. Results are in N/m.
180° Peel by ASTM D-903. Results are in N/m.
Holding Power by ASTM D-6463. Substrate was stainless steel, conditions were 1 by 1 inch contact area and 2 kg load. Results are in hr.
SAFT by ASTM D-4498. Substrate was Mylar, conditions were 1 by 1 inch contact area, 0.5 kg load, oven temperature increased at 22° C./hr. Results are in ° C.

The following examples are given to illustrate the invention of the present application. Because these examples are given for illustrative purposes only, the invention should not be deemed limited thereto.

### Example 1

### Compatibility of Block Copolymer 1 with Ester Plasticizers

Copolymer 1 was tested to determine its compatibility with aromatic esters. To that end Benzoflex® 131 and Santicizer® 160 were combined with Copolymer 1 as a solution in toluene and poured into molds. The toluene solvent was driven off to yield 2.5 mm thick dry films which were evaluated qualitatively. The results of this evaluation of 5 compositions prepared in accordance with this example are set forth in Table 1.

TABLE 1

| Component, | Composition | | | | |
|---|---|---|---|---|---|
| % by Wt | A | B | C | D | E |
| Copolymer 1 | 100 | 75 | 50 | 75 | 50 |
| Benzoflex ® | 0 | 25 | 50 | 0 | 0 |
| 131 | | | | | |
| Santicizer ® | 0 | 0 | 0 | 25 | 50 |
| 160 | | | | | |
| Appearance | Hard, Stiff | Flexible, | Tacky, | Flexible, | Tacky, |
| | | Strong | transfers | Strong | transfers |

### Example 2

### Hot Melt Adhesive Compositions and Evaluation of Same

A series of hot melt adhesive compositions shown in Table 2, which incorporated Copolymer 1, were prepared utilizing one of the compatible plasticizers employed in Example 1.

Qualitatively, Compositions C and E seemed to be the best adhesive composition candidates. Therefore, those two compositions were dissolved in toluene (40% by wt) and cast upon 25-micron Mylar polyester film. The cast film dried to a 40-micron adhesive film and was tested to determine its pressure sensitive adhesive properties.

The results, summarized below in Table 2, suggest that both compositions, especially Composition E, have a reasonable balance of PSA properties.

TABLE 2

| | Composition | | | | |
|---|---|---|---|---|---|
| | A | B | C | D | E |
| Component, % by Wt | | | | | |
| Copolymer 1 | 75 | 50 | 50 | 50 | 50 |
| Wingtack ® 86 | 0 | 50 | 25 | 0 | 0 |
| Picco ® 6100 | 0 | 0 | 0 | 50 | 25 |
| Santicizer ® 160 | 25 | 0 | 25 | 0 | 25 |
| Irganox ® 010 | 0.5 | 0.5 | 0.5 | 0.5 | 0.5 |

Composition Physical Properties

| | | | | | |
|---|---|---|---|---|---|
| R&B Softening Pt, ° C. | 129 | >138 | 104 | 134 | 94 |
| Melt Viscosity, Pa · s | 350 | 310 | 54 | 170 | 31 |
| Color | None | Light | Light | Brown | Orange |
| | | Yellow | Yellow | | |
| Tack | Very | Very | Tacky | None | Tacky |
| | Slight | Slight | | | |
| Hardness | Soft | Hard | Soft | Very | Soft |
| | | but | | Hard | |
| | | flexible | | | |
| Elasticity | Elastic | Stiff | Fairly | Brittle | Fairly |
| | but not | | elastic | | elastic |
| | snappy | | | | |

Pressure Sensitive Adhesive Properties

| | | |
|---|---|---|
| Rolling ball tack, cm | >30 | >30 |
| Loop tack, N/m | 80 | 340 |
| 180° Peel, N/m | 140 | 390 |
| Holding Power, hr | 2¹ | 8¹ |
| SAFT, ° C. | 53 | 64 |
| Finger tack | Fair | Fair |

¹Cohesion failure.

### Example 3

### Preparation of Hot Melt Adhesive Compositions and Evaluation of Same

A series of adhesive formulations were prepared by combining Copolymer 1 with tackifying agents, plasticizers and hydrocarbon oil. The formulations were prepared as hot melts which were thereupon cast as 50% solutions in toluene onto 25-micron Mylar polyester film. Each of the films, having a dry adhesive thickness of 40 microns, was tested to determine its PSA properties.

It is emphasized that the major distinction between the compositions of instant Example 3 and those of Example 2 supra was the substitution of Kristalex® 3100 in place of Picco® 6100. This substitution of solid aromatic resins yielded lighter colored adhesives.

TABLE 3

| Composition | | | | |
|---|---|---|---|---|
| A | B | C | D | E |

| | | | | | |
|---|---|---|---|---|---|
| Component, % by | | | | | |
| Wt | | | | | |
| Copolymer 1 | 50 | 42.5 | 35 | 42.5 | 42.5 |
| Kristalex ® 3100 | 25 | 32.5 | 40 | 25 | 17.5 |
| Wingtack ® 86 | 0 | 0 | 0 | 7.5 | 7.5 |
| Santicizer ® 160 | 25 | 25 | 25 | 25 | 25 |
| Shellflex ® 371 | 0 | 0 | 0 | 0 | 7.5 |
| Irganox ® 1010 | 0.5 | 0.5 | 0.5 | 0.5 | 0.5 |

Pressure Sensitive Adhesive Properties

| | | | | | |
|---|---|---|---|---|---|
| Rolling ball tack, cm | >30 | >30 | >30 | >30 | 9 |
| Loop tack, N/m | 300 | 260 | 420¹ | 190 | 590² |
| 180° Peel, N/m | 510 | 700 | 630¹ | 600² | 330² |
| Holding Power, hr | 4.3¹ | 4.3¹ | 2.7¹ | 3.3¹ | 0.6¹ |
| SAFT, ° C. | 65 | 60 | 55 | 58 | 52 |
| Finger tack | Fair | Fair | Fair | Fair | Good |

¹Cohesion failure.
²Adhesive left stain on steel.

The results summarized in Table 3 indicate that a reasonable balance of tack, peel, and shear, as well as an SAFT of 61° C., was obtained utilizing a formulation of 42.5% by weight of a copolymer within the scope of the present invention.

### Comparative Example 1

### Hot Melt Adhesives Compositions Including an Aliphatic Ester Plasticizer

A series of five adhesive compositions, outside the scope of the present invention, were prepared in accordance with the procedure utilized in Example 3 except that the plasticizer employed was an aliphatic ester, rather than an aromatic ester and thus outside the scope of the invention. These compositions were tested to determine their PSA properties.

A summary of these compositions and their PSA properties appear in Table 4.

TABLE 4

| | Composition | | |
|---|---|---|---|
| Component, % by Wt | A | B | C |
| Kristalex ® 3100 | 25 | 32.5 | 40 |
| Finester ® EH-25 | 25 | 25 | 25 |
| Irganox ® 1010 | 0.5 | 0.5 | 0.5 |

Pressure Sensitive Adhesive Properties

| | | | |
|---|---|---|---|
| Rolling ball tack, cm | >30 | >30 | >30 |
| Loop tack, N/m | 20 | 30 | 80 |
| 180° Peel, N/m | 230¹ | 120¹ | 210¹ |
| Holding Power, hr | 16¹ | 1.5¹ | 0.5¹ |
| SAFT, ° C. | 55 | 48 | 40 |
| Finger tack | Poor | Fair | Good |

¹Cohesion failure.

The replacement of a C₁₂-C₁₅ alkyl octanoate ester for the aromatic phthalate ester of Example 3 produced adhesives having inferior properties. The compositions summarized in Table 4 have lower loop tack, lower peel and lower SAFT compared to the corresponding compositions of the present invention summarized in Table 3.

### Example 4

### Pressure Sensitive Adhesive Compositions Containing A Liquid Aromatic Resin Plasticizer

A series of adhesive compositions was prepared in accordance with the procedure set forth in Example 3 and Comparative Example 1. The major distinction between the compositions of the present example and the compositions of Example 3 and Comparative Example 1 was that the plasticizer was a liquid aromatic resin rather than an ester plasticizer. Moreover, no tackifying agents were included in the compositions of this example.

The results of these preparations are summarized in Table 5.

TABLE 5

| Component, % Wt | A | B | C | D |
|---|---|---|---|---|
| Copolymer 1 | 50 | 42.5 | 35 | 27.5 |
| KRATON ® D1155 | 0 | 0 | 0 | 7.5 |
| Piccolastic ® A5 | 50 | 57.5 | 65 | 65 |
| Irganox ® 1010 | 0.5 | 0.5 | 0.5 | 0.5 |

Pressure Sensitive Adhesive Properties

| | | | | |
|---|---|---|---|---|
| Rolling ball tack, cm | >30 | >30 | >30 | 12 |
| Loop tack, N/m | 400 | 780 | 1150 | 960 |
| 180° Peel, N/m | 630 | 650 | 630 | 420 |
| Holding Power, hr | 72¹ | 9¹ | 1.9¹ | 0.9¹ |
| SAFT, ° C. | 68 | 58 | 49 | 47 |
| Finger tack | Poor | Fair | Good | Good |

¹Cohesion failure.

The results of these tests establish that an adhesive composition containing the copolymer of the present invention with a liquid aromatic resin produces good adhesive properties even in the absence of a tackifying agent.

### Example 5

### Stability of Hot Melt Adhesives During Hot Melt Aging

A series hot melt adhesive stability tests comparing an adhesive of the present invention, utilizing a block copolymer of this invention, with prior art adhesive compositions which comprise block copolymers outside the scope of the present invention, was prepared.

The adhesives were mixed in a sigma blade mixer under nitrogen for about 1 hour at 175° C. 50 grams of each mixed adhesive were placed in each of four 200 ml beakers. The beakers were covered with aluminum foil and placed in an oven at 160° C. One beaker of each adhesive was removed from the oven after 0, 8, 24, 48 and 96 hours. Melt viscosity was measured at 177° C. of each sample.

The results of these tests are summarized in Table 6.

TABLE 6

| Component, | Copoly- | KRATON ® | KRATON ® | KRATON ® |
|---|---|---|---|---|
| % by Wt | mer 1 | D1162 | D1155 | MD6932 |
| Block Copolymer | 35 | 35 | 35 | 35 |
| Kristalex ® 3100 | 40 | 0 | 0 | 0 |
| Regalite ® R 1100 | 0 | 50 | 50 | 44 |
| Santicizer ® 160 | 25 | 0 | 0 | 0 |
| Drakeol ® 34 | 0 | 15 | 15 | 21 |
| Irganox ® 1010 | 0.5 | 0.5 | 0.5 | 0.5 |

Aging Characteristics
Melt Viscosity, Pa · s

| | | | | |
|---|---|---|---|---|
| 0 hr | 6.22 | 11.72 | 6.74 | 2.32 |
| 8 hrs | 6.22 | 9.62 | 6.92 | 2.30 |
| 24 hrs | 4.24 | 2.98 | 4.42 | 2.22 |
| 48 hrs | 2.34 | 1.34 | 3.30 | 2.18 |
| 96 hrs | 1.12 | 0.33 | 4.34 | 2.22 |

Melt Viscosity Retention, %

| | | | | |
|---|---|---|---|---|
| 0 hr | 100 | 100 | 100 | 100 |
| 8 hrs | 100 | 82 | 103 | 99 |
| 24 hrs | 68 | 25 | 66 | 96 |
| 48 hrs | 38 | 11 | 49 | 94 |
| 96 hrs | 18 | 3 | 64 | 96 |

The results of Example 5, as summarized in Table 6, illustrate that all three adhesive compositions which contain polymers outside the present invention followed the expected behavior. The composition containing KRATON® MD6932, the S-EB-S polymer, as expected, exhibited excellent stability such that the melt viscosity did not change over 96 hours at 160° C. The composition containing KRATON® D1162, the S-I-S polymer, exhibited melt viscosity reduction evidencing degradation by scission. The composition containing KRATON® D1155, the S-B-S polymer, showed a reduction in melt viscosity after the first 48 hours but then showed an increase in melt viscosity after the next 48 hours, evidencing degradation by both scission and crosslinking. Those skilled in the art appreciate that if heat aging were continued beyond 96 hours, this polymer would gel.

The results with Copolymer 1, which is within the scope of the present invention, demonstrated a continuous drop in viscosity, evidencing degradation by scission. However, this degradation by scission was slower than the scission degradation exhibited by the S-I-S polymer.

The above observations were confirmed by gel permeation chromatography (GPC) which established that there was little degradation of the S-EB-S polymer; degradation of the S-I-S polymer was exclusively by scission; and degradation of the S-B-S polymer was by both crosslinking and scission, as evidenced by the presence of both lower and higher molecular weight fragments. The examination of the composition containing Copolymer 1, which is a block copolymer within the scope of the present invention, showed it degraded only to lower molecular weight fragments evidencing that the degradation mechanism was scission.

Although the invention is independent of any theory explaining its operation, it is theorized that the bulky styrene units in the butadiene/styrene copolymer mid-block sterically hinder the free radicals, formed by oxidation of the butadiene units, from recombining to form higher molecular weight species.

### Example 6

### Preparation of Non-Pressure Sensitive Hot Melt Packaging Adhesive Compositions and Evaluation of Properties

A series of adhesive compositions, useful in packaging where pressure sensitivity is not essential, was prepared. In each case, Copolymer 1 was combined with a liquid plasticizer and a tackifying agent. As a comparison, one of the non-PSA compositions did not include a plasticizer.

The adhesives were mixed in a sigma blade mixer at about 175° C. for about 1 hour under nitrogen. Melt viscosity was measured to indicate how the adhesive would process as a hot melt. Softening point and SAFT were measured to indicate the upper service temperature of the adhesive. T-peel samples of cardboard bonded to another piece of cardboard with hot melt adhesive were prepared to indicate how well the adhesive would bond to cardboard. To prepare the T-peel samples, hot adhesive from the mixer was applied to one piece of cardboard. Another piece of cardboard was immediately applied to the hot adhesive on the first piece of cardboard. The thus bonded cardboard was permitted to cool to room temperature and the pieces were pulled apart manually. Fiber tear, denoted in Table 7 as “T-peel,” was rated as none, poor, good or very good.

A summary of these compositions and the results of testing done to each of them appears in Table 7.

TABLE 7

| | Composition | | | | | |
|---|---|---|---|---|---|---|
| | A | B | C | D | E | F |
| Component, % by wt | | | | | | |
| Copolymer 1 | 40 | 30 | 40 | 40 | 30 | 30 |
| Wingtack ® 86 | 60 | 60 | 50 | 0 | 0 | 0 |
| Kristalex ® 3100 | 0 | 0 | 0 | 50 | 60 | 50 |
| Santicizer ® 160 | 0 | 10 | 10 | 10 | 10 | 20 |
| Irganox ® 1010 | 0.5 | 0.5 | 0.5 | 0.5 | 0.5 | 0.5 |

Adhesive Properties

| | | | | | | |
|---|---|---|---|---|---|---|
| MeltVisc@177° C., Pa · s | 110 | 7.2 | 21 | 31 | 10.5 | 5.0 |
| R&B Softening Pt, ° C. | >135 | 114 | 123 | 107 | 100 | 85 |
| SAFT, ° C. | 86 | 63 | 72 | 65 | 69 | 56 |
| T-peel on Cardboard | Good | Very | Very | Very | Very | Very |
| | | good | good | good | good | good |

Appearance Characteristics

| | | | | | | |
|---|---|---|---|---|---|---|
| Color | Tan | Tan | Tan | None | None | None |
| Clarity | Opaque | Opaque | Opaque | Clear | Clear | Clear |
| Tack | None | None | None | None | None | None |
| Flexibility | Brittle | Pliable | Pliable | Brittle | Brittle | Very |
| | | | | | | pliable |

The results summarized in Table 7 establish that the absence of a plasticizer in Composition A produced a non-pressure sensitive adhesive providing good adhesion to cardboard. However, the melt viscosity of Composition A was far too high and the resultant adhesive product of Composition A was far too brittle to be an effective non-pressure sensitive adhesive. Compositions B and C, which contained 10% by weight plasticizer, produced good results. Compositions D and E were good candidates except that the cooled adhesive products of these compositions were brittle. Finally, Composition F was acceptable. However, its concentration of 20% plasticizer, the maximum concentration acceptable for a non-pressure sensitive adhesive within the scope of the present invention, yielded a soft, very pliable adhesive.

### Example 7

### Preparation of Non-Pressure Sensitive Hot Melt Adhesive Compositions and Evaluation of Properties

Another series of non-pressure sensitive adhesive compositions was prepared. In each case, Copolymer 1 was combined with a solid plasticizer and a tackifying agent. The adhesives were mixed and tested the same as in Example 6.

Results summarized in Table 8 show that the solid plasticizer is also effective in providing adhesives that have high softening point and SAFT while maintaining an acceptably low melt viscosity.

TABLE 8

| Component, % by wt | A | B | C | D |
|---|---|---|---|---|
| Copolymer 1 | 35 | 35 | 35 | 35 |
| Wingtack 86 | 55 | 45 | 0 | 0 |
| Kristalex 3100 | 0 | 0 | 55 | 45 |
| Benzoflex 352 | 10 | 20 | 10 | 20 |
| Irganox 1010 | 0.5 | 0.5 | 0.5 | 0.5 |
| Adhesive Properties | | | | |
| Melt Visc @ 177° C., Pa · s | 12.5 | 8.4 | 22.5 | 11.5 |
| R&B Softening Pt. ° C. | 123 | 106 | 111 | 97 |
| SAFT, ° C. | 71 | 73 | 81 | 69 |
| Appearance | | | | |
| Characteristics | | | | |
| Clarity | Opaque | Opaque | Clear | Clear |
| Flexibility | Good | Very good | Brittle | Good |

### Example 8

### Hot Melt Aging Stability Testing of Non-PSA Adhesive Compositions

A series of non-PSA compositions was prepared and tested to determine their hot melt aging stability using the same procedure as was used in Example 5. The compositions included Composition A, within the scope of the present invention, and a series of non-PSA compositions outside the scope of the present invention.

Table 9 provides a summary of these compositions and their hot melt aging characteristics.

TABLE 9

| | Composition | | | |
|---|---|---|---|---|
| Component, % by Wt | A | B | C | D |
| Copolymer 1 | 30 | 0 | 0 | 0 |
| KRATON ® D1164 | 0 | 30 | 0 | 0 |
| KRATON ® D1102 | 0 | 0 | 30 | 0 |
| KRATON ® G1652 | 0 | 0 | 0 | 30 |
| Wingtack ® 86 | 60 | 60 | 60 | 0 |
| Regalite ® R1100 | 0 | 0 | 0 | 60 |
| Santicizer ® 160 | 10 | 0 | 0 | 0 |
| Drakeol ® 34 | 0 | 10 | 10 | 10 |
| Irganox ® 1010 | 0.5 | 0.5 | 0.5 | 0.5 |

Heat Aging Characteristics
Melt Visc @ 177° C., Pa · s

| | | | | |
|---|---|---|---|---|
| 0 hr | 7.25 | 3.31 | 8.67 | 8.70 |
| 8 hrs | 6.71 | 2.45 | 7.18 | 8.73 |
| 24 hrs | 5.65 | 1.72 | 5.78 | 8.68 |
| 48 hrs | 4.37 | 0.92 | 4.60 | 8.75 |
| 96 hrs | 2.74 | 0.32 | Elastic gel | 8.75 |

Melt Visc Retention, %

| | | | | |
|---|---|---|---|---|
| 0 hr | 100 | 100 | 100 | 100 |
| 8 hrs | 100 | 82 | 103 | 99 |
| 24 hrs | 68 | 25 | 66 | 96 |
| 48 hrs | 38 | 11 | 49 | 94 |
| 96 hrs | 18 | 3 | 64 | 96 |

Composition A, which included Copolymer 1 within the scope of the present invention, demonstrated a continuously decreasing melt viscosity throughout the 96 hours of aging at 160° C. This demonstrated that scission was the exclusive degradation mechanism. Composition B, which contained a S-I-S linear block copolymer, often employed in non-PSA adhesive compositions, although demonstrating scission as the degradation mechanism, lost viscosity continuously and at a much faster rate than Composition A. Composition C, which included a S-B-S linear block copolymer, employed in non-PSA adhesive compositions, failed by gelling, yielding a soft elastic gel after 96 hours. Earlier in the heat aging process the composition lost viscosity continuously. This pattern demonstrated that degradation occurred by both scission and crosslinking. Composition D, comprising a S-EB-S linear block copolymer, retained viscosity throughout, showing that this hydrogenated polymer had excellent degradation resistance. GPC measurements confirmed the polymer degradation mechanisms surmised from the viscosity changes.

The above embodiments and examples are given to illustrate the scope and spirit of the present invention. These embodiments and examples will make apparent, to those skilled in the, art, other embodiments and examples. These other embodiments and examples are within the contemplation of the present invention. Therefore, the present invention should be limited only by the appended claims.

What is claimed is:

1. An adhesive composition comprising a plasticizer selected from the group consisting of an aromatic ester and a liquid aromatic resin; and at least one unsaturated block copolymer, wherein:
(1) said block copolymer having a mono alkenyl arene content equal to or greater than 60 weight percent, based on the total weight of the block copolymer;
(2) said block copolymer having a modulus less than 125,000 psi; and
(3) said block copolymer comprises at least two A blocks and at least one B block, each A block independently selected from mono alkenyl arene polymer blocks and each B block independently selected from
(a) polymer blocks having at least one conjugated diene and at least one mono alkenyl arene and having a random distribution;
(b) polymer blocks having at least one conjugated diene and at least one mono alkenyl arene and having a blocked distribution;
(c) polymer blocks having at least one conjugated diene and at least one mono alkenyl arene and having a tapered distribution; and
(d) polymer blocks having at least one conjugated diene and at least one mono alkenyl arene and having a controlled distribution.

2. The adhesive composition of claim 1 further comprising a solid aromatic resin tackifying agent.

3. The adhesive composition of claim 1 wherein said block copolymer is present in a concentration from about 25% to about 50%, and said plasticizer is present in a concentration from about 50% to about 75%, said percentages being by weight, based on the total weight of the adhesive composition.

4. The adhesive composition of claim 2 wherein said block copolymer is present in a concentration from about 25% to about 50%, said plasticizer is present in a concentration from about 10% to about 30% and said solid aromatic resin tackifying agent is present in a concentration in a range from about 15% to about 60%, said percentages being by weight, based on the total weight of the adhesive composition.

5. The adhesive composition of claim 1 wherein said plasticizer is said aromatic ester.

6. The adhesive composition of claim 5 wherein said aromatic ester is selected from the group consisting of benzoate esters and phthalate esters.

7. The adhesive composition of claim 1 wherein said plasticizer is selected from the group consisting of butyl benzyl phthalate, 2,2,4-trimethyl pentanediol dibenzoate, isodecyl benzoate, 1,4-cyclohexane dimethanol dibenzoate and a liquid aromatic resin having a softening point of about 5° C. or less.

8. The adhesive composition of claim 1 wherein said plasticizer is said liquid aromatic resin, said liquid aromatic resin having a soften point of about 5° C. or less.

9. The adhesive composition of claim 1 wherein in each B block, the mono alkenyl arene comprises styrene and the conjugated diene comprises butadiene, isoprene, or mixtures thereof.

10. The adhesive composition of claim 9 wherein each B block has a random distribution.

11. The adhesive composition of claim 9 wherein each B block has a blocked distribution.

12. The adhesive composition of claim 9 wherein each B block has a tapered distribution.

13. The adhesive composition of claim 9 wherein each B block has a controlled distribution.

14. The adhesive composition of claim 1 wherein said mono alkenyl arene content is from about 60 to about 80 weight percent, based on the total block copolymer.

15. The adhesive composition of claim 1 wherein said block copolymer is linear coupled or multi-arm coupled having symmetrical arms.

16. The adhesive composition of claim 1 wherein said block copolymer is linear coupled or multi-arm coupled having unsymmetrical arms.
